(19) United States
(12) Patent Application Publication
(10) Pub. No.: US 2024/0101747 A1
(43) Pub. Date: Mar. 28, 2024

(54) WATERBORNE POLYURETHANE MATERIAL AND METHOD FOR MANUFACTURING GLOVES UTILIZING THE WATERBORNE POLYURETHANE MATERIAL

(71) Applicant: SHIJIAZHUANG HONGRAY GROUP CO., LTD., Jinzhou City (CN)

(72) Inventors: Guixi LIU, Shijiazhuang (CN); Shuming DAI, Shijiazhuang (CN); Zhanmin LYU, Shijiazhuang (CN); Panli ZHANG, Shijiazhuang (CN); Kemiao WANG, Shijiazhuang (CN)

(21) Appl. No.: 18/314,070

(22) Filed: May 8, 2023

(30) Foreign Application Priority Data
Sep. 26, 2022 (CN) 202211169127.7

(51) Int. Cl. C08G 18/10; B29C 41/00; B29C 41/14; B29C 41/46; C08G 18/08; C08G 18/22; C08G 18/42

(52) U.S. Cl. CPC C08G 18/10; B29C 41/003; B29C 41/14; B29C 41/46; C08G 18/0866; C08G 18/227; C08G 18/4244; B29K 2075/00

(57) ABSTRACT

The present disclosure relates to a method for preparing a waterborne polyurethane material, including the following acts: mixing polyester polyol and toluene diisocyanate, heating up to react, adding a mixed solution of dimethylolpropionic acid and butanediol to react, adding polyethylene glycol to react, adding trimethylolpropane to react, adding a catalyst to react and testing NCO value until reaching 1-3% of the theoretical value, adding a solvent and stirring uniformly to obtain a polyurethane prepolymer, cooling the prepolymer to <15° C., adding triethylamine for neutralization, adding pure water for thorough emulsification, adding ethylenediamine for chain extension, removing the solvent to obtain the waterborne polyurethane material. The present disclosure also relates to a method for preparing gloves, including: cleaning a mold, adding coagulants and demoulding agents, immersing in the waterborne polyurethane added with cross-linking agents, and then drying. The method of the present disclosure has low cost, simple process acts (steps) and short reaction time.

### CROSS-REFERENCE TO RELATED APPLICATION(S)

This application claims priority to and the benefit of Chinese Patent Application No. 202211169127.7, filed on Sep. 26, 2022, the entire content of which is incorporated herein by reference.

### BACKGROUND

### 1. Technical Field

The present disclosure relates to the technical field of gloves, in particular to a waterborne polyurethane material and preparation method for applying the waterborne polyurethane material to gloves.

### 2. Description of the Related Art

Waterborne polyurethane is a polyurethane system which utilizes water instead of organic solvents as the disperse medium, and as the main solvent is water, the waterborne polyurethane has advantages of non-pollution, environmental friendliness, easy cleaning of residual adhesive, good or suitable compatibility, easy modification and so on.

The waterborne polyurethane will be a necessary substitute for rubbers, and its application field is very extensive. Through emulsification, the waterborne polyurethane can be utilized to produce medical surgical gloves, disposable examination gloves, high-end epidemic prevention and protection gloves for both (e.g., simultaneously) military and civilian utilization, modern new materials such as family planning products (such as condoms and/or finger condoms), raw materials for high-end medical device accessories (gastroscope, lithotripsy balloon, cerebrovascular nerve balloon, gynecological midwifery balloon and/or ultrasonic balloon), new coatings for fabrics, leather products and so on. For example, the biodegradable waterborne polyurethane gloves have promising prospect and may become the next-generation disposable gloves.

Chinese patent application No. 2005100023663 (the entire content of which is incorporated herein by reference) discloses a waterborne aromatic polyurethane elastomer and preparation method thereof, and the waterborne aromatic polyurethane elastomer is obtained by reacting a compound with active hydrogen, polybutylene glycol and polypropylene glycol, however, such polyether based waterborne polyurethane has relatively high production cost, and long production time, which limits the production of businesses.

Chinese patent application No. 202111019221X (the entire content of which is incorporated herein by reference) discloses a polyurethane examination glove. During the process of preparing the glove, coagulant and demoulding agent are added separately, resulting in multiple process acts (steps); and the process of immersing into the waterborne polyurethane emulsion first and then into the release agent leads to poor demoulding effect.

### SUMMARY

Aspects according to one or more embodiments of the present disclosure are directed toward a waterborne polyurethane material and method for manufacturing gloves utilizing the waterborne polyurethane material.

Additional aspects will be set forth in part in the description which follows and, in part, will be apparent from the description, or may be learned by practice of the presented embodiments of the disclosure.

According to embodiments of the present disclosure, a method for preparing a waterborne polyurethane material includes:
1) reacting polyester polyol and toluene diisocyanate at a temperature of 85° C. to 100° C. for 50-70 minutes in a reaction vessel;
2) adding a mixed solution of dimethylolpropionic acid and butanediol to the reaction vessel, and reacting at a temperature of 90° C.-110° C. for 30-35 minutes;
3) adding polyethylene glycol to the reaction vessel, and reacting at a temperature of 90° C.-95° C. for 30-35 minutes;
4) adding trimethylolpropane to the reaction vessel and reacting at a temperature of 90° C.-95° C. for 30-35 minutes;
5) adding a catalyst to the reaction vessel, reacting at a temperature of 95° C.-100° C., and testing NCO value until reaching 1-3% of a theoretical value;
6) adding a solvent to the reaction vessel and stirring uniformly to prepare a polyurethane prepolymer;
7) cooling the prepolymer to a temperature of less than 15° C. and adding triethylamine for neutralization for 3-5 minutes;
8) adding pure water and emulsifying the prepolymer for 30-35 minutes to obtain thoroughly emulsified prepolymer;
9) adding ethylenediamine to the emulsified prepolymer for chain extension for 30-35 minutes; and
10) removing the solvent to obtain the waterborne polyurethane material.

The reacting of polyester polyol and toluene diisocyanate may be at 90° C.

The solvent may be acetone.

The catalyst may be bismuth isooctanoate and/or bismuth neodecanoate.

A molar ratio among the polyester polyol, the toluene diisocyanate, the dimethylolpropionic acid, the butanediol, the polyethylene glycol, the trimethylolpropane, the catalyst, the solvent, the triethylamine, the pure water and the 1 ethylenediamine may be 2:6.1-6.3:0.9-1.0:0.9-1.0:0.08-0.09:0.66-0.67:0.001:63-64:0.99-1.0:460-470:1.17-1.18.

A molar ratio among the polyester polyol, the toluene diisocyanate, the dimethylolpropionic acid, the butanediol, the polyethylene glycol, the trimethylolpropane, the catalyst, the solvent, the triethylamine, the pure water and the ethylenediamine may be 2:6.229:0.994:0.986:0.089:0.663:0.001:63.473:0.994:460.815:1.173.

The polyester polyol may be a reaction product of adipic acid and ethylene glycol, the polyester polyol may have an acid value of less than or equal to 0.3 mgKOH/g, a hydroxyl value of 54-58 mgKOH/g, a viscosity of 450-600 cP/75° C., and a water content of less than or equal to 0.03%.

The dimethylolpropionic acid may have an acid value of 410-425 mgKOH/g, a water content of less than or equal to 0.03% and a hydroxyl value of greater than or equal to 24%.

The butanediol may be 1,4-butanediol and/or 2,3-butanediol.

The butanediol may be 1,4-butanediol.

According to embodiments of the present disclosure, a waterborne polyurethane material may be manufactured utilizing the method, wherein a solid content of the waterborne polyurethane material may be 40% to 43%, based on a total weight of the waterborne polyurethane material.

According to embodiments of the present disclosure, a method for preparing gloves from the waterborne polyurethane material includes:
(1) immersing a first-state dry mold in a coagulant mixture of 1-5% calcium nitrate and 1-5% release agent under a condition of 50° C.-60° C. for 10-15 seconds, and then lifting it out to obtain a first-state wet mold;
(2) drying the first-state wet mold under a condition of 120° C.-130° C. for 30 seconds to obtain a second-state dry mold;
(3) immersing the second-state dry mold in a mixture of the waterborne polyurethane material and a cross-linking agent under a condition of 50° C.-60° C. for 10-30 seconds, and then lifting it out to obtain a second-state wet mold with a glove film layer;
(4) drying the second-state wet mold with the glove film layer under a condition of 120° C.-130° C. for 30 seconds to obtain a third-state dry mold with the glove film layer;
(5) immersing the third-state dry mold with the glove film layer in an anti-stick coating solution under a condition of 50° C.-60° C. for 5-10 seconds, and then lifting it out to obtain a third-state wet mold with the glove film layer;
(6) rolling an edge of the glove film layer on the third-state wet mold utilizing a lip rolling machine to obtain a fourth-state wet mold with the glove film layer;
(7) drying the fourth-state wet mold with the glove film layer under a condition of 100° C.-120° C. for 5 minutes to obtain a fourth-state dry mold with the glove film layer;
(8) drying the fourth-state dry mold with the glove film layer under a condition of 80° C.-89° C. for 10 minutes to obtain a fifth-state dry mold with the glove film layer; and
(9) demolding to obtain a polyurethane glove.

The cross-linking agent may be an amino resin.

The cross-linking agent may be 1-10% based on a total weight of the mixture of the waterborne polyurethane material and the cross-linking agent.

The cross-linking agent may be 2-5% based on a total weight of the mixture of the waterborne polyurethane material and the cross-linking agent.

A solid content of the mixture of the waterborne polyurethane material and the cross-linking agent may be 17-19% based on a total weight of the mixture of the waterborne polyurethane material and the cross-linking agent.

The method may further include, after the (3) immersing and prior to the (4) drying:
drying the second-state wet mold with the glove film layer under a condition of 120° C.-130° C. for 30 seconds to have a dried mold,
immersing the dried mold in the mixture of the waterborne polyurethane material and the cross-linking agent for a second time for 10-15 seconds, and
lifting it out to thereby obtain the second-state wet mold with the glove film layer after the second operation.

The method may further include cleaning a mold prior to the (1) immersing of the first-state dry mold in the coagulant mixture, wherein the cleaning includes:
act 1, immersing the mold in an acid washing tank with a pH of 1-2 under a condition of 50° C.-60° C. for 10-15 seconds, and then lifting it out;
act 2, immersing the mold in a water washing tank under a condition of 50° C.-60° C. for 10-15 seconds, and then lifting it out;
act 3, immersing the mold in an alkaline washing tank with a pH of 13-14 under a condition of 50° C.-60° C. for 10-15 seconds, and then lifting it out;
act 4, cleaning the mold with a plate brush under a condition of 50° C.-60° C. for 15-20 seconds;
act 5, immersing the mold in a water washing tank under a condition of 50° C.-60° C. for 10-15 seconds, and then lifting it out; and
act 6, drying the mold under a condition of 120° C.-130° C. for 30 seconds to obtain the first-state dry mold.

According to one or more embodiments of the present disclosure, a glove may be manufactured by the method.

The glove may have a tensile strength of 6.0 N or greater and an elongation rate of 650% or greater.

### DETAILED DESCRIPTION

The purpose and/or aspect of the present disclosure is to provide a waterborne polyurethane material with low cost, simple process act (step)s and short reaction time, and preparation method for applying the waterborne polyurethane material to gloves.

The technical solutions of the present disclosure are as follow:

A method for preparing a waterborne polyurethane material, including the following acts:
1) reacting polyester polyol and toluene diisocyanate at a temperature of 85° C. to 100° C. for 50-70 minutes in a reaction vessel;
2) adding a mixed solution of dimethylolpropionic acid and butanediol to the reaction vessel, and reacting at a temperature of 90° C.-110° C. for 30-35 minutes;
3) adding polyethylene glycol to the reaction vessel, and reacting at a temperature of 90° C.-95° C. for 30-35 minutes;
4) adding trimethylolpropane to the reaction vessel and reacting at a temperature of 90° C.-95° C. for 30-35 minutes;
5) adding a catalyst to the reaction vessel, reacting at a temperature of 95° C.-100° C., and testing NCO value until reaching 1-3% of a theoretical value;
6) adding a solvent to the reaction vessel and stirring uniformly to prepare a polyurethane prepolymer;
7) cooling the prepolymer to a temperature of less than 15° C. and adding triethylamine for neutralization for 3-5 minutes;
8) adding pure water and emulsifying the prepolymer for 30-35 minutes to obtain thoroughly emulsified prepolymer;
9) adding ethylenediamine to the emulsified prepolymer for chain extension for 30-35 minutes; and
10) removing the solvent to obtain the waterborne polyurethane material.

In reacting the polyester polyol and toluene diisocyanate, the polyester polyol and toluene diisocyanate are mixed and the mixture is heated up to a temperature of 85° C. to 100° C. to react for 50-70 minutes. In some embodiments, the temperature is 85° C. The polyester polyol is a reaction product of adipic acid and ethylene glycol and is fully miscible with the toluene diisocyanate without the need to add solvents and surfactants. Furthermore, in an embodiment, the polyester polyol has a molecular weight Mn=2000 and is much cheaper in cost than polybutylene glycol and/or polypropylene glycol with a molecular weight Mn=2000.

In adding polyethylene glycol and reacting at a temperature of 90° C.-95° C. for 30-35 minutes, the polyethylene glycol is utilized to achieve better hydrophilic performance and easier emulsification.

In adding trimethylolpropane and reacting at a temperature of 90° C.-95° C. for 30-35 minutes, the trimethylolpropane is utilized as a crosslinking agent, which can promote the crosslinking reaction, resulting in better performance of the formed film in all aspects.

In adding the catalyst and reacting at a temperature of 95° C.-100° C., and testing NCO value until reaching 1-3% of the theoretical value, the theoretical value refers to a total amount of the NCO groups in the reagents added into the reaction vessel. The catalyst may be bismuth isooctanoate and/or bismuth neodecanoate, which can promote the reaction more completely. Adding the catalyst at this stage of the reaction (e.g., not from the beginning of act 1)) may further control the reaction rate, and promote complete reaction of all reagents (e.g., residual reagents from acts 1 to 4).

In some embodiments, the molar ratio among the polyester polyol, the toluene diisocyanate, the dimethylolpropionic acid, the butanediol, the polyethylene glycol, the trimethylolpropane, the catalyst (e.g., bismuth isooctanoate and/or the bismuth neodecanoate), the solvent, the triethylamine, the pure water and the ethylenediamine may be 2:6.1-6.3:0.9-1.0:0.9-1.0:0.08-0.09:0.66-0.67:0.001:63-64:0.99-1.0:460-470:1.17-1.18;

In some embodiments, the molar ratio among the polyester polyol, the toluene diisocyanate, the dimethylolpropionic acid, the butanediol, the polyethylene 1 glycol, the trimethylolpropane, the catalyst (e.g., bismuth isooctanoate and/or the bismuth neodecanoate), the solvent, the triethylamine, the pure water and the ethylenediamine may be 2:6.229:0.994:0.986:0.089:0.663:0.001:63.473:0.994:460.815:1.173.

In some embodiments, the polyester polyol may be a reaction product of adipic acid and ethylene glycol, the polyester polyol has an acid value of less than or equal to (≤) 0.3 mgKOH/g, a hydroxyl value of 54-58 mgKOH/g, a viscosity of 450-600 cP/75° C., and a water content (e.g., amount) of less than or equal to (≤) 0.03%.

In some embodiments, the dimethylolpropionic acid has an acid value of 410-425 mgKOH/g, a water content (e.g., amount) of less than or equal to (≤) 0.03% and a hydroxyl value of greater than or equal to (≤) 24%.

In some embodiments, the butanediol may be 1,4-butanediol and/or 2,3-butanediol. In some embodiments, the butanediol may be 1,4-butanediol, which facilitates the reaction for chain extension mainly due to its linear chain. The present application involves two chain extension reactions, the first involving the addition of butanediol and the second involving the addition of ethylenediamine. The two chain extension reactions form long molecular chains, resulting in better physical and chemical properties of the product.

In some embodiments, the solvent may be acetone. As a diluent, it can adjust the viscosity of the solution.

In some embodiments, the catalyst may be bismuth isooctanoate or bismuth neodecanoate.

In some embodiments, the waterborne polyurethane material manufactured utilizing the method above has a solid content (e.g., amount) of 40% to 43%, based on a total weight of the waterborne polyurethane material. In some embodiments, the waterborne polyurethane material has a viscosity of 10 cps to 50 cps, a pH of 9 to 9.5, and a particle size diameter D90 of 0.1 μm to 0.3 μm. The term “particle size diameter D90” refers to a particle size distribution parameter that represents the diameter below which 90% of the particles in a sample fall.

A method for preparing gloves from the waterborne polyurethane material includes the following acts:
(1) immersing a first-state dry mold in a coagulant mixture of 1-5% calcium nitrate and 1-5% release agent under a condition of 50° C.-60° C. for 10-15 seconds, and then lifting it out to obtain a first-state wet mold;
(2) drying the first-state wet mold under a condition of 120° C.-130° C. for 30 seconds to obtain a second-state dry mold;
(3) immersing the second-state dry mold in a mixture of the waterborne polyurethane material and a cross-linking agent under a condition of 50° C.-60° C. for 10-30 seconds, and then lifting it out to obtain a second-state wet mold with a glove film layer;
(4) drying the second-state wet mold with the glove film layer under a condition of 120° C.-130° C. for 30 seconds to obtain a third-state dry mold with the glove film layer;
(5) immersing the third-state dry mold with the glove film layer in an anti-stick coating solution under a condition of 50° C.-60° C. for 5-10 seconds, and then lifting it out to obtain a third-state wet mold with the glove film layer;
(6) rolling an edge of the glove film layer on the third-state wet mold (e.g., to form a cuff portion) utilizing a lip rolling machine to obtain a fourth-state wet mold with the glove film layer;
(7) drying the fourth-state wet mold with the glove film layer under a condition of 100° C.-120° C. for 5 minutes to obtain a fourth-state dry mold with the glove film layer;
(8) drying the fourth-state dry mold with the glove film layer under a condition of 80° C.-89° C. for 10 minutes to obtain a fifth-state dry mold with the glove film layer; and
(9) demolding to obtain a polyurethane glove.

In some embodiments, the method may further include a second (e.g., repeated) operation of immersing in the mixture of waterborne polyurethane and the cross-linking agent, for example or specifically after the act (3). For example, the method further includes:
drying the second-state wet mold with the glove film layer under a condition of 120° C.-130° C. for 30 seconds to have a dried mold,
immersing the dried mold in the mixture of the waterborne polyurethane material and the cross-linking agent for a second time for 10-15 seconds, and
lifting it out to thereby obtain the second-state wet mold with the glove film layer after the second operation.

The cross-linking agent may be an amino resin. In some embodiments, the cross-linking agent may be added at 1-10% based on a total weight of the mixture of the waterborne polyurethane material and the cross-linking agent. In some embodiments, the cross-linking agent may be added at 2-5% based on a total weight of the mixture of the waterborne polyurethane material and the cross-linking agent. In some embodiments, the ratio of dry weight of the cross-linking agent (e.g, amino resin) to dry weight of the polyurethane (e.g., the waterborne polyurethane material after removing the water) may be 0.02:1. The probability of pinhole formation in the film layer can be reduced by the two-act (step) (e.g., repeated) immersion in the waterborne polyurethane added with the cross-linking agent compared with a one-act (step) immersion (e.g., immersion only once) in the waterborne polyurethane added with the cross-linking agent. In some embodiments, the solid content (e.g., amount) of the mixture of the waterborne polyurethane material and the cross-linking agent is 17-19% based on a total weight of the mixture of the waterborne polyurethane material and the cross-linking agent. In some embodiments, water is added to the mixture of the waterborne polyurethane material and the cross-linking agent to obtain the solid content (e.g., amount) of 17-19%.

In some embodiments, the method further includes cleaning a mold prior to the immersing of the first-state dry mold in the coagulant mixture:
act 1, immersing the mold in an acid washing tank with a pH of 1-2 under a condition of 50° C.-60° C. for 10-15 seconds, and then lifting it out;
act 2, immersing the mold in a water washing tank under a condition of 50° C.-60° C. for 10-15 seconds, and then lifting it out;
act 3, immersing the mold in an alkaline washing tank with a pH of 13-14 under a condition of 50° C.-60° C. for 10-15 seconds, and then lifting it out;
act 4, cleaning the mold with a plate brush under a condition of 50° C.-60° C. for 15-20 seconds;
act 5, immersing the mold in a water washing tank under a condition of 50° C.-60° C. for 10-15 seconds, and then lifting it out; and
act 6, drying the mold under a condition of 120° C.-130° C. for 30 seconds to obtain the first-state dry mold.

The release agent and the anti-stick coating solution may be any suitable one utilized in the related art. Non-limiting examples of the release agent may include silicone oil, fatty acid esters, and polyethylene glycol (PEG), and non-limiting examples of the anti-stick coating material may include polyvinyl alcohol (PVA), polyurethane dispersion (PUD), fluorinated polymers (e.g. polytetrafluoroethylene or PTFE) and silicone rubber emulsion.

In some embodiments, a glove is manufactured by the method according to embodiments of the present disclosure. The glove may have a tensile strength of 6.0 N or greater and an elongation rate of 650% or greater.

The beneficial effects of the present disclosure may be as follows:

The present disclosure utilizes a cross-linking agent to improve the physical properties of gloves. Polyester polyurethane has great advantages in terms of cost, but its physical properties are not significantly superior to polyether polyurethane. The present disclosure perfectly solves this shortcoming by adding a cross-linking agent. Currently, the related art production time of waterborne polyurethane is more than 10 hours, however, in the present disclosure, the reaction time is shortened to 4 hours (e.g., by increasing the reaction temperature whereas the related art utilizes a temperature of less than 80° C. in manufacturing a waterborne polyurethane material), therefore the reaction time in the present disclosure is much shorter than that in the related art. The mixture of the release agent and the coagulant of the present disclosure simplifies the process. At present, the polyurethane utilized in the related art to produce gloves are polyether polyurethanes, which have a relatively higher cost than polyester polyurethanes of the present disclosure. The present disclosure reacts polyester polyols of adipic acid and ethylene glycol with toluene diisocyanate to produce polyester polyurethanes, which has a lower cost.

The waterborne polyurethane of the present disclosure has properties such as non-pollution, environmental friendliness, easy cleaning of residue (e.g., residual glue), good or suitable compatibility, and easy modification, especially short production time and low energy consumption.

### DETAILED DESCRIPTION

### Example 1

### I. Technical Specification of Raw Materials

1. Polyester polyols of adipic acid and ethylene glycol: acid value≤0.3 mgKOH/g, hydroxyl value: 54-58 mgKOH/g, viscosity: 450-600 cP/75° C., water content (e.g., amount): ≤0.03%;
2. Toluene diisocyanate: TDI-80
3. Dihydroxymethylpropionic acid: acid value: 410-425 mgKOH/g, water content (e.g., amount): ≤0.03%, hydroxyl value: ≥24%;
4. 1,4-butanediol: active ingredient: 98-100%, water content (e.g., amount): ≤0.05%;

### II. Preparation Method of High Elastic Aromatic Polyester Waterborne Polyurethane Materials:

1) 400 g of polyester polyol and 108.5 g of toluene diisocyanate were mixed and heated up to 90° C. to react for 1 hour;
2) a mixture of 13.34 g of dihydroxymethylpropionic acid and 8.89 g of butanediol was added, and reacted at a temperature of 90° C.-110° C. for 30 minutes;
3) 13.34 g of polyethylene glycol was added and reacted at a temperature of 90° C.-95° C. for 30 minutes;
4) 8.89 g of trihydroxymethylpropane was added and reacted at a temperature of 90° C.-95° C. for 30 minutes;
5) 0.2 g of bismuth isooctanoate was added, reacted at a temperature of 95° C.-100° C., and the NCO value was tested until 1-3% of the theoretical value was reached;
6) 380 g of acetone was added as a solvent and stirred uniformly to obtain a polyurethane prepolymer;
7) the polyurethane prepolymer was cooled to <15° C., 10.06 g of triethylamine was added for neutralization for 5 minutes;
8) 829.5 g of pure water was added for thorough emulsification for 30 minutes;
9) 7.05 g of ethylenediamine was added for chain extension for 30 minutes;
10) the solvent was removed; and
11) a waterborne polyurethane was obtained.

### III. Manufacturing Process of Glove:

Act (step) 1, a first-state dry mold was immersed in an acid washing tank with a pH of 1-2 under a condition of 50° C.-60° C. for 10-15 seconds and then lifted out to obtain a first-state wet mold;
Act (step) 2, the first-state wet mold was immersed in a water washing tank under a condition of 50° C.-60° C. for 10-15 seconds and then lifted out to obtain a second-state wet mold;
Act (step) 3, the second-state wet mold was immersed in an alkaline washing tank with a pH of 13-14 under a condition of 50° C.-60° C. for 10-15 seconds and then lifted out to obtain a third-state wet mold;
Act (step) 4, the third-state wet mold was cleaned (e.g., scrubbed) with a plate brush under a condition of 50° C.-60° C. for 15-20 seconds to obtain a fourth-state wet mold;
Act (step) 5, the fourth-state wet mold was immersed in a water washing tank under a condition of 50° C.-60° C. for 10-15 seconds and then lifted out to obtain a fifth-state wet mold;
Act (step) 6, the fifth-state wet mold was dried under a condition of 120° C.-130° C. for 30 seconds to obtain a second-state dry mold;
Act (step) 7, the second-state dry mold was immersed in a coagulant mixture of 1-5% calcium nitrate and 1-5% release agent under a condition of 50° C.-60° C. for 10-15 seconds and then lifted out to obtain a sixth-state wet mold;
Act (step) 8, the sixth-state wet mold was dried under a condition of 120° C.-130° C. for 30 seconds to obtain a third-state dry mold;
Act (step) 9, the third-state dry mold was immersed in a waterborne polyurethane I added with a cross-linking agent (e.g., a first mixture of waterborne polyurethane mixed with a cross-linking agent) under a condition of 50° C.-60° C. for 10-15 seconds and then lifted out to obtain a seventh-state wet mold with a glove film layer;
Act (step) 10, the seventh-state wet mold with the glove film layer was dried under a condition of 120° C.-130° C. for 30 seconds to obtain a fourth-state dry mold with the glove film layer;
Act (step) 11, the fourth-state dry mold with the glove film layer was immersed in a waterborne polyurethane II added with a cross-linking agent (e.g., a second mixture of waterborne polyurethane mixed with a cross-linking agent) under a condition of 50° C.-60° C. for 10-15 seconds and then lifted out to obtain an eighth-state wet mold with a glove film layer;
Act (step) 12, the eighth-state wet mold with a glove film layer was dried under a condition of 120° C.-130° C. for 30 seconds to obtain a fifth-state dry mold with the glove film layer;
Act (step) 13, the fifth-state dry mold with the glove film layer was immersed in an anti-stick coating solution under a condition of 50° C.-60° C. for 5-10 seconds and then lifted out to obtain a ninth-state wet mold with the glove film layer;
Act (step) 14, the ninth-state wet mold with the glove film layer was rolled through a lip rolling machine to obtain a tenth-state wet mold with the glove film layer;
Act (step) 15, the tenth-state wet mold with the glove film layer was dried under a condition of 100° C.-120° C. for 5 minutes to obtain a sixth-state dry mold with the glove film layer;
Act (step) 16, the sixth-state dry mold with the glove film layer was dried under a condition of 80° C.-89° C. for 10 minutes to obtain a seventh-state dry mold with the glove film layer; and
Act (step) 16, the mold was removed to obtain the polyurethane examination glove.

### Example 2

### I. Technical Specification of Raw Materials

5. Polyester polyols of adipic acid and ethylene glycol: acid value≤0.3 mgKOH/g, hydroxyl value: 54-58 mgKOH/g, viscosity: 450-600 cP/75° C., water content (e.g., amount)≤0.03%;
6. Toluene diisocyanate: TDI-80
7. Dihydroxymethylpropionic acid: acid value: 410-425 mgKOH/g, water content (e.g., amount): ≤0.03%, hydroxyl value: ≥24%;
8. 1,4-butanediol: active ingredient: 98-100%, water content (e.g., amount): ≤0.05%;

### II. Preparation Method of High Elastic Aromatic Polyester Waterborne Polyurethane Materials:

1) 400 g of polyester polyol and 106.3 g of toluene diisocyanate were mixed and heated up to 90° C. to react for 1 hour;
2) a mixture of 12.08 g of dihydroxymethylpropionic acid and 8.11 g of butanediol was added, and reacted at a temperature of 90° C.-110° C. for 30 minutes;
3) 13.49 g of polyethylene glycol was added and reacted at a temperature of 90° C.-95° C. for 30 minutes;
4) 8.85 g of trihydroxymethylpropane was added and reacted at a temperature of 90° C.-95° C. for 30 minutes;
5) 0.2 g of bismuth isooctanoate was added, reacted at a temperature of 95° C.-100° C., and the NCO value was tested until 1-3% of the theoretical value was reached;
6) 377 g of acetone was added as a solvent and stirred uniformly to obtain a polyurethane prepolymer;
7) the prepolymer was cooled to <15° C., 10.02 g of triethylamine was added for neutralization for 5 minutes;
8) 828 g of pure water was added for thorough emulsification for 30 minutes;
9) 7.03 g of ethylenediamine was added for chain extension for 30 minutes;
10) the solvent was removed; and
11) a waterborne polyurethane was obtained.

### III. Manufacturing Process of Glove:

Act (step) 1, a first-state dry mold was immersed in an acid washing tank with a pH of 1-2 under a condition of 50° C.-60° C. for 10-15 seconds and then lifted out to obtain a first-state wet mold;
Act (step) 2, the first-state wet mold was immersed in a water washing tank under a condition of 50° C.-60° C. for 10-15 seconds and then lifted out to obtain a second-state wet mold;
Act (step) 3, the second-state wet mold was immersed in an alkaline washing tank with a pH of 13-14 under a condition of 50° C.-60° C. for 10-15 seconds and then lifted out to obtain a third-state wet mold;
Act (step) 4, the third-state wet mold was cleaned (e.g., scrubbed) with a plate brush under a condition of 50° C.-60° C. for 15-20 seconds to obtain a fourth-state wet mold;
Act (step) 5, the fourth-state wet mold was immersed in a water washing tank under a condition of 50° C.-60° C. for 10-15 seconds and then lifted out to obtain a fifth-state wet mold;
Act (step) 6, the fifth-state wet mold was dried under a condition of 120° C.-130° C. for 30 seconds to obtain a second-state dry mold;
Act (step) 7, the second-state dry mold was immersed in a coagulant mixture of 1-5% calcium nitrate and 1-5% release agent under a condition of 50° C.-60° C. for 10-15 seconds and then lifted out to obtain a sixth-state wet mold;
Act (step) 8, the sixth-state wet mold was dried under a condition of 120° C.-130° C. for 30 seconds to obtain a third-state dry mold;
Act (step) 9, the third-state dry mold was immersed in a waterborne polyurethane I added with a cross-linking agent (e.g., a first mixture of waterborne polyurethane mixed with a cross-linking agent) under a condition of 50° C.-60° C. for 10-30 seconds and then lifted out to obtain a seventh-state wet mold with a glove film layer;
Act (step) 10, the seventh-state wet mold with the glove film layer was dried under a condition of 120° C.-130° C. for 30 seconds to obtain a fourth-state dry mold with the glove film layer;
Act (step) 11, the fourth-state dry mold with the glove film layer was immersed in a waterborne polyurethane II added with a cross-linking agent (e.g., a second mixture of waterborne polyurethane mixed with a cross-linking agent) under a condition of 50° C.-60° C. for 10-15 seconds and then lifted out to obtain an eighth-state wet mold covering a glove film layer;
Act (step) 12, the eighth-state wet mold with a glove film layer was dried under a condition of 120° C.-130° C. for 30 seconds to obtain a fifth-state dry mold with the glove film layer;
Act (step) 13, the fifth-state dry mold with the glove film layer was immersed in an anti-stick coating solution under a condition of 50° C.-60° C. for 5-10 seconds and then lifted out to obtain a ninth-state wet mold with the glove film layer;
Act (step) 14, the ninth-state wet mold with the glove film layer was rolled through a lip rolling machine to obtain a tenth-state wet mold with the glove film layer;
Act (step) 15, the tenth-state wet mold with the glove film layer was dried under a condition of 100° C.-120° C. for 5 minutes to obtain a sixth-state dry mold with the glove film layer;
Act (step) 16, the sixth-state dry mold with the glove film layer was dried under a condition of 80° C.-89° C. for 10 minutes to obtain a seventh-state dry mold with the glove film layer; and
Act (step) 17, the mold was removed to obtain the polyurethane examination glove.

### Example 3

### I. Technical Indicators of Raw Materials

9. Polyester polyols of adipic acid and ethylene glycol: acid value≤0.3 mgKOH/g, hydroxyl value: 54-58 mgKOH/g, viscosity: 450-600 cP/75° C., water content (e.g., amount) ≤0.03%;
10. Toluene diisocyanate: TDI-80
11. Dihydroxymethylpropionic acid: acid value: 410-425 mgKOH/g, water content (e.g., amount) ≤0.03%, hydroxyl value ≥24%;
12. 1,4-butanediol: active ingredient: 98-100%, water content (e.g., amount) ≤0.05%;

### II. Preparation Method of High Elastic Aromatic Polyester Waterborne Polyurethane Materials:

1) 400 g of polyester polyol and 109.7 g of toluene diisocyanate were mixed and heated up to 90° C. to react for 1 hour;
2) a mixture of 13.42 g of dihydroxymethylpropionic acid and 9.02 g of butanediol was added, and reacted at a temperature of 90° C.-110° C. for 30 minutes;
3) 11.99 g of polyethylene glycol was added and reacted at a temperature of 90° C.-95° C. for 30 minutes;
4) 8.98 g of trihydroxymethylpropane was added and reacted at a temperature of 90° C.-95° C. for 30 minutes;
5) 0.2 g of bismuth isooctanoate was added, reacted at a temperature of 95° C.-100° C., and the NCO value was tested until 1-3% of the theoretical value was reached;
6) 383 g of acetone was added as a solvent and stirred uniformly to obtain a polyurethane prepolymer;
7) the prepolymer was cooled to <15° C., 10.12 g of triethylamine was added for neutralization for 5 minutes;
8) 846 g of pure water was added for full emulsification for 30 minutes;
9) 7.09 g of ethylenediamine was added for chain extension for 30 minutes;
10) the solvent was removed; and
11) a waterborne polyurethane was obtained;

### III. Manufacturing Process of Glove

Act (step) 1, a first-state dry mold was immersed in a pickling tank with a pH of 1-2 under a condition of 50° C.-60° C. for 10-15 seconds and then lifted out to obtain a first-state wet mold;
Act (step) 2, the first-state wet mold was immersed in a water washing tank under a condition of 50° C.-60° C. for 10-15 seconds and then lifted out to obtain a second-state wet mold;
Act (step) 3, the second-state wet mold was immersed in an alkaline washing tank with a pH of 13-14 under a condition of 50° C.-60° C. for 10-15 seconds and then lifted out to obtain a third-state wet mold;
Act (step) 4, the third-state wet mold was cleaned (e.g., scrubbed) with a plate brush under a condition of 50° C.-60° C. for 15-20 seconds to obtain a fourth-state wet mold;
Act (step) 5, the fourth-state wet mold was immersed in a water washing tank under a condition of 50° C.-60° C. for 10-15 seconds and then lifted out to obtain a fifth-state wet mold;
Act (step) 6, the fifth-state wet mold was dried under a condition of 120° C.-130° C. for 30 seconds to obtain a second-state dry mold;
Act (step) 7, the second-state dry mold was immersed in a coagulant mixture of 1-5% calcium nitrate and 1-5% release agent under a condition of 50° C.-60° C. for 10-15 seconds and then lifted out to obtain a sixth-state wet mold;
Act (step) 8, the sixth-state wet mold was dried under a condition of 120° C.-130° C. for 30 seconds to obtain a third-state dry mold;
Act (step) 9, the third-state dry mold was immersed in a waterborne polyurethane I added with a cross-linking agent (e.g., a first mixture of waterborne polyurethane mixed with a cross-linking agent) under a condition of 50° C.-60° C. for 10-30 seconds and then lifted out to obtain a seventh-state wet mold with a glove film layer;
Act (step) 10, the seventh-state wet mold with the glove film layer was dried under a condition of 120° C.-130° C. for 30 seconds to obtain a fourth-state dry mold with the glove film layer;
Act (step) 11, the fourth-state dry mold with the glove film layer was immersed in a waterborne polyurethane II added with a cross-linking agent (e.g., a second mixture of waterborne polyurethane mixed with a cross-linking agent) under a condition of 50° C.-60° C. for 10-15 seconds and then lifted out to obtain an eighth-state wet mold covering a glove film layer;
Act (step) 12, the eighth-state wet mold with a glove film layer was dried under a condition of 120° C.-130° C. for 30 seconds to obtain a fifth-state dry mold with the glove film layer;
Act (step) 13, the fifth-state dry mold with the glove film layer was immersed in an anti-stick coating solution under a condition of 50° C.-60° C. for 5-10 seconds and then lifted out to obtain a ninth-state wet mold with the glove film layer;
Act (step) 14, the ninth-state wet mold with the glove film layer was rolled through a lip rolling machine to obtain a tenth-state wet mold with the glove film layer;
Act (step) 15, the tenth-state wet mold with the glove film layer was dried under a condition of 100-120° C. for 5 minutes to obtain a sixth-state dry mold with the glove film layer;
Act (step) 16, the sixth-state dry mold with the glove film layer was dried under a condition of 80-89° C. for 10 minutes to obtain a seventh-state dry mold with the glove film layer; and
Act (step) 17, the mold was removed to obtain the polyurethane examination glove.

### Comparative Example 1

Compared with Example 1, this example is the same as Example 1 except that trihydroxymethylpropane is not added.

### I. Technical Specification of Raw Materials

13. Polyester polyols of adipic acid and ethylene glycol: acid value: ≤0.3 mgKOH/g, hydroxyl value: 54-58 mgKOH/g, viscosity: 450-600 cP/75° C., water content (e.g., amount) ≤0.03%;
14. Toluene diisocyanate: TDI-80
15. Dihydroxymethylpropionic acid: acid value: 410-425 mgKOH/g, water content (e.g., amount) ≤0.03%, hydroxyl value ≥24%;
16. 1,4-butanediol: active ingredient: 98-100%, water content (e.g., amount) 0.05%;

### II. Preparation Method of High Elastic Aromatic Polyester Waterborne Polyurethane Materials:

1) 400 g of polyester polyol and 90.05 g of toluene diisocyanate were mixed and heated up to 90° C. to react for 1 hour;
2) a mixture of 13.34 g of dihydroxymethylpropionic acid and 8.89 g of butanediol was added, and reacted at a temperature of 90° C.-110° C. for 30 minutes;
3) 13.34 g of polyethylene glycol was added and reacted at a temperature of 90° C.-95° C. for 30 minutes;
4) 0.2 g of bismuth isooctanoate was added, reacted at a temperature of 95° C.-100° C., and the NCO value was tested until 1-3% of the theoretical value was reached;
5) 380 g of acetone was added as a solvent and stirred uniformly to obtain a polyurethane prepolymer;
6) the prepolymer was cooled to <15° C., triethylamine was added for neutralization for 5 minutes;
7) pure water was added for full emulsification for 30 minutes;
8) ethylenediamine was added for chain extension for 30 minutes;
9) the solvent was removed; and
10) a waterborne polyurethane was obtained;

### III. Manufacturing Process of Glove:

Act (step) 1, a first-state dry mold was immersed in a pickling tank with a pH of 1-2 under a condition of 50° C.-60° C. for 10-15 seconds and then lifted out to obtain a first-state wet mold;
Act (step) 2, the first-state wet mold was immersed in a water washing tank under a condition of 50° C.-60° C. for 10-15 seconds and then lifted out to obtain a second-state wet mold;
Act (step) 3, the second-state wet mold was immersed in an alkaline washing tank with a pH of 13-14 under a condition of 50° C.-60° C. for 10-15 seconds and then lifted out to obtain a third-state wet mold;
Act (step) 4, the third-state wet mold was cleaned (e.g., scrubbed) with a plate brush under a condition of 50° C.-60° C. for 15-20 seconds to obtain a fourth-state wet mold;
Act (step) 5, the fourth-state wet mold was immersed in a water washing tank under a condition of 50° C.-60° C. for 10-15 seconds and then lifted out to obtain a fifth-state wet mold;
Act (step) 6, the fifth-state wet mold was dried under a condition of 120° C.-130° C. for 30 seconds to obtain a second-state dry mold;
Act (step) 7, the second-state dry mold was immersed in a coagulant mixture of 1-5% calcium nitrate and 1-5% release agent under a condition of 50° C.-60° C. for 10-15 seconds and then lifted out to obtain a sixth-state wet mold;
Act (step) 8, the sixth-state wet mold was dried under a condition of 120° C.-130° C. for 30 seconds to obtain a third-state dry mold;
Act (step) 9, the third-state dry mold was immersed in a waterborne polyurethane I added with a cross-linking agent (e.g., a first mixture of waterborne polyurethane mixed with a cross-linking agent) under a condition of 50° C.-60° C. for 10-30 seconds and then lifted out to obtain a seventh-state wet mold with a glove film layer;
Act (step) 10, the seventh-state wet mold with the glove film layer was dried under a condition of 120° C.-130° C. for 30 seconds to obtain a fourth-state dry mold with the glove film layer;
Act (step) 11, the fourth-state dry mold with the glove film layer was immersed in a waterborne polyurethane II added with a cross-linking agent (e.g., a second mixture of waterborne polyurethane mixed with a cross-linking agent) under a condition of 50° C.-60° C. for 10-15 seconds and then lifted out to obtain an eighth-state wet mold covering a glove film layer;
Act (step) 12, the eighth-state wet mold with a glove film layer was dried under a condition of 120° C.-130° C. for 30 seconds to obtain a fifth-state dry mold with the glove film layer;
Act (step) 13, the fifth-state dry mold with the glove film layer was immersed in an anti-stick coating solution under a condition of 50° C.-60° C. for 5-10 seconds and then lifted out to obtain a ninth-state wet mold with the glove film layer;
Act (step) 14, the ninth-state wet mold with the glove film layer was rolled through a lip rolling machine to obtain a tenth-state wet mold with the glove film layer;
Act (step) 15, the tenth-state wet mold with the glove film layer was dried under a condition of 100-120° C. for 5 minutes to obtain a sixth-state dry mold with the glove film layer;
Act (step) 16, the sixth-state dry mold with the glove film layer was dried under a condition of 80-89° C. for 10 minutes to obtain a seventh-state dry mold with the glove film layer; and
Act (step) 17, the mold was removed to obtain the polyurethane examination glove.

### Comparative Example 2

Compared with Example 1, this example is the same as Example 1 except that bismuth isooctanoate is not added.

### I. Technical Specification of Raw Materials

17. Polyester polyols of adipic acid and ethylene glycol: acid value: ≤0.3 mgKOH/g, hydroxyl value: 54-58 mgKOH/g, viscosity: 450-600 cP/75° C., water content (e.g., amount) ≤0.03%;
18. Toluene diisocyanate: TDI-80
19. Dihydroxymethylpropionic acid: acid value: 410-425 mgKOH/g, water content (e.g., amount) ≤0.03%, hydroxyl value ≥24%;
20. 1,4-butanediol: active ingredient: 98-100%, water content (e.g., amount): 0.05%;

### II. Preparation Method of High Elastic Aromatic Polyester Waterborne Polyurethane Materials:

1) 400 g of polyester polyol and 108.5 g of toluene diisocyanate were mixed and heated up to 90° C. to react for 1 hour;
2) a mixture of 13.34 g of dihydroxymethylpropionic acid and 8.89 g of butanediol was added, and reacted at a temperature of 90° C.-110° C. for 30 minutes;
3) 13.34 g of polyethylene glycol was added and reacted at a temperature of 90° C.-95° C. for 30 minutes;
4) 8.89 g of trihydroxymethylpropane was added and reacted at a temperature of 90° C.-95° C. for 30 minutes;
5) 380 g of acetone was added as a solvent and stirred uniformly to obtain a polyurethane prepolymer;
6) the prepolymer was cooled to <15° C., triethylamine was added for neutralization for 5 minutes;
7) pure water was added for full emulsification for 30 minutes;
8) ethylenediamine was added for chain extension for 30 minutes;
9) the solvent was removed; and
10) a waterborne polyurethane was obtained.

### III. Manufacturing Process of Glove:

Act (step) 1, a first-state dry mold was immersed in a pickling tank with a pH of 1-2 under a condition of 50° C.-60° C. for 10-15 seconds and then lifted out to obtain a first-state wet mold;
Act (step) 2, the first-state wet mold was immersed in a water washing tank under a condition of 50° C.-60° C. for 10-15 seconds and then lifted out to obtain a second-state wet mold;
Act (step) 3, the second-state wet mold was immersed in an alkaline washing tank with a pH of 13-14 under a condition of 50° C.-60° C. for 10-15 seconds and then lifted out to obtain a third-state wet mold;
Act (step) 4, the third-state wet mold was cleaned (e.g., scrubbed) with a plate brush under a condition of 50° C.-60° C. for 15-20 seconds to obtain a fourth-state wet mold;
Act (step) 5, the fourth-state wet mold was immersed in a water washing tank under a condition of 50° C.-60° C. for 10-15 seconds and then lifted out to obtain a fifth-state wet mold;
Act (step) 6, the fifth-state wet mold was dried under a condition of 120° C.-130° C. for 30 seconds to obtain a second-state dry mold;
Act (step) 7, the second-state dry mold was immersed in a coagulant mixture of 1-5% calcium nitrate and 1-5% release agent under a condition of 50° C.-60° C. for 10-15 seconds and then lifted out to obtain a sixth-state wet mold;
Act (step) 8, the sixth-state wet mold was dried under a condition of 120° C.-130° C. for 30 seconds to obtain a third-state dry mold;
Act (step) 9, the third-state dry mold was immersed in a waterborne polyurethane I added with a cross-linking agent (e.g., a first mixture of waterborne polyurethane mixed with a cross-linking agent) under a condition of 50° C.-60° C. for 10-30 seconds and then lifted out to obtain a seventh-state wet mold with a glove film layer;
Act (step) 10, the seventh-state wet mold with the glove film layer was dried under a condition of 120° C.-130° C. for 30 seconds to obtain a fourth-state dry mold with the glove film layer;
Act (step) 11, the fourth-state dry mold with the glove film layer was immersed in a waterborne polyurethane II added with a cross-linking agent (e.g., a second mixture of waterborne polyurethane mixed with a cross-linking agent) under a condition of 50° C.-60° C. for 10-15 seconds and then lifted out to obtain an eighth-state wet mold with a glove film layer;
Act (step) 12, the eighth-state wet mold with a glove film layer was dried under a condition of 120° C.-130° C. for 30 seconds to obtain a fifth-state dry mold with the glove film layer;
Act (step) 13, the fifth-state dry mold with the glove film layer was immersed in an anti-stick coating solution under a condition of 50° C.-60° C. for 5-10 seconds and then lifted out to obtain a ninth-state wet mold with the glove film layer;
Act (step) 14, the ninth-state wet mold with the glove film layer was rolled through a lip rolling machine to obtain a tenth-state wet mold with the glove film layer;
Act (step) 15, the tenth-state wet mold with the glove film layer was dried under a condition of 100-120° C. for 5 minutes to obtain a sixth-state dry mold with the glove film layer;
Act (step) 16, the sixth-state dry mold with the glove film layer was dried under a condition of 80-89° C. for 10 minutes, then a seventh-state dry mold with the glove film layer; and
Act (step) 17, the mold was removed to obtain the polyurethane examination glove.

### Comparative Example 3

Compared with Example 1, this example is the same as Example 1 except that butanediol is not added.

### I. Technical Specification of Raw Materials

21. Polyester polyols of adipic acid and ethylene glycol: acid value: ≤0.3 mgKOH/g, hydroxyl value: 54-58 mgKOH/g, viscosity: 450-600 cP/75° C., water content (e.g., amount): ≤0.03%;
22. Toluene diisocyanate: TDI-80
23. Dihydroxymethylpropionic acid: acid value: 410-425 mgKOH/g, water content (e.g., amount): ≤0.03%, hydroxyl value: ≥24%;
24. 1,4-butanediol: active ingredient: 98-100%, water content (e.g., amount): 0.05%;

### II. Preparation Method of High Elastic Aromatic Polyester Waterborne Polyurethane Materials:

1) 400 g of polyester polyol and 90.22 g of toluene diisocyanate were mixed and heated up to 90° C. to react for 1 hour;
2) 13.34 g of dihydroxymethylpropionic acid was added, and reacted at a temperature of 90° C.-110° C. for 30 minutes;
3) 13.34 g of polyethylene glycol was added and reacted at a temperature of 90° C.-95° C. for 30 minutes;
4) 8.89 g of trihydroxymethylpropane was added and reacted at a temperature of 90° C.-95° C. for 30 minutes;
5) 0.2 g of bismuth isooctanoate was added, reacted at a temperature of 95° C.-100° C., and the NCO value was tested until 1-3% of the theoretical value was reached;
6) 380 g of acetone was added as a solvent and stirred uniformly to obtain a polyurethane prepolymer;
7) the prepolymer was cooled to <15° C., triethylamine was added for neutralization for 5 minutes;
8) pure water was added for full emulsification for 30 minutes;
9) ethylenediamine was added for chain extension for 30 minutes;
10) the solvent was removed; and
11) a waterborne polyurethane was obtained;

### III. Manufacturing Process of Glove:

Act (step) 1, a first-state dry mold was immersed in a pickling tank with a pH of 1-2 under a condition of 50° C.-60° C. for 10-15 seconds and then lifted out to obtain a first-state wet mold;
Act (step) 2, the first-state wet mold was immersed in a water washing tank under a condition of 50° C.-60° C. for 10-15 seconds and then lifted out to obtain a second-state wet mold;
Act (step) 3, the second-state wet mold was immersed in an alkaline washing tank with a pH of 13-14 under a condition of 50° C.-60° C. for 10-15 seconds and then lifted out to obtain a third-state wet mold;
Act (step) 4, the third-state wet mold was cleaned (e.g., scrubbed) with a plate brush under a condition of 50° C.-60° C. for 15-20 seconds to obtain a fourth-state wet mold;
Act (step) 5, the fourth-state wet mold was immersed in a water washing tank under a condition of 50° C.-60° C. for 10-15 seconds and then lifted out to obtain a fifth-state wet mold;
Act (step) 6, the fifth-state wet mold was dried under a condition of 120° C.-130° C. for 30 seconds to obtain a second-state dry mold;
Act (step) 7, the second-state dry mold was immersed in a coagulant mixture of 1-5% calcium nitrate and 1-5% release agent under a condition of 50° C.-60° C. for 10-15 seconds and then lifted out to obtain a sixth-state wet mold;
Act (step) 8, the sixth-state wet mold was dried under a condition of 120° C.-130° C. for 30 seconds to obtain a third-state dry mold;
Act (step) 9, the third-state dry mold was immersed in a waterborne polyurethane I added with a cross-linking agent (e.g., a first mixture of waterborne polyurethane mixed with a cross-linking agent) under a condition of 50° C.-60° C. for 10-30 seconds and then lifted out to obtain a seventh-state wet mold with a glove film layer;
Act (step) 10, the seventh-state wet mold with the glove film layer was dried under a condition of 120° C.-130° C. for 30 seconds to obtain a fourth-state dry mold with the glove film layer;
Act (step) 11, the fourth-state dry mold with the glove film layer was immersed in a waterborne polyurethane II added with a cross-linking agent (e.g., a second mixture of waterborne polyurethane mixed with a cross-linking agent) under a condition of 50° C.-60° C. for 10-15 seconds and then lifted out to obtain an eighth-state wet mold with a glove film layer;
Act (step) 12, the eighth-state wet mold with a glove film layer was dried under a condition of 120° C.-130° C. for 30 seconds to obtain a fifth-state dry mold with the glove film layer;
Act (step) 13, the fifth-state dry mold with the glove film layer was immersed in an anti-stick coating solution under a condition of 50° C.-60° C. for 5-10 seconds and then lifted out to obtain a ninth-state wet mold with the glove film layer;
Act (step) 14, the ninth-state wet mold with the glove film layer was rolled through a lip rolling machine to obtain a tenth-state wet mold with the glove film layer;
Act (step) 15, the tenth-state wet mold with the glove film layer was dried under a condition of 100-120° C. for 5 minutes to obtain a sixth-state dry mold with the glove film layer;
Act (step) 16, the sixth-state dry mold with the glove film layer was dried under a condition of 80-89° C. for 10 minutes to obtain a seventh-state dry mold with the glove film layer; and
Act (step) 17, the mold was removed to obtain the polyurethane examination glove.

The physical and chemical properties of the products of Examples of the present disclosure and Comparative Examples are shown in Table 1.

Testing Method for Elongation at Break and Tensile Strength (tensile breaking force):

Test Conditions: Testing under the conditions of temperature 23±2° C. and relative humidity 50±5%.

Utilizing a dumbbell-shaped cutting die (Die D) to obtain a dumbbell-shaped sample from the palm, back of the hand, or cuff area of the test sample gloves. 13 specimens from 13 gloves were tested for the tensile strength and elongation according to European standard EN455 (with tensile strength in unit of N and the narrowest part of the test specimen being 3 mm) for each of Examples 1 to 3 and Comparative Examples 1 to 3, and an average value is shown in Table 1. The specimen may also be tested according to ASTM D412 and 6319 (sample being cut with a dumbbell-shaped cutting die (Die C) with tensile strength in unit of MPa and the narrowest part of the test specimen being 6 mm).

TABLE 1

| Examples | Tensile strength/N | Elongation Rate/% |
|---|---|---|
| Example 1 | 6.3 | 652 |
| Example 2 | 6.2 | 663 |
| Example 3 | 6.2 | 657 |
| Comparative Example 1 | 4.2 | 734 |
| Comparative Example 2 | 6.1 | 642 |
| Comparative Example 3 | 5.5 | 708 |

The examples of the present application disclosed above are only intended to illustrate the present disclosure. These examples neither describe fully all details nor limit the present disclosure to specific embodiments. Obviously, many modifications and variations can be made based on the contents of the description of the present disclosure.

In the present disclosure, when particles are spherical, “diameter” indicates a particle diameter or an average particle diameter, and when the particles are non-spherical, the “diameter” indicates a major axis length or an average major axis length.

The use of “may” when describing embodiments of the present invention refers to “one or more embodiments of the present invention.” It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

As used herein, the singular forms “a”, “an” and “the” are intended to include the plural forms as well, unless the context clearly indicates otherwise.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

These embodiments selected and specifically in the description are intended to better explain the principles and practical applications of the present disclosure, so that those skilled in the art can better understand and utilize the present disclosure. The present disclosure is to be limited only by the claims, along with their full scope and equivalents thereof.

What is claimed is:

1. A method for preparing a waterborne polyurethane material, the method comprising:
1) reacting polyester polyol and toluene diisocyanate at a temperature of 85° C. to 100° C. for 50-70 minutes in a reaction vessel;
2) adding a mixed solution of dimethylolpropionic acid and butanediol to the reaction vessel, and reacting at a temperature of 90° C.-110° C. for 30-35 minutes;
3) adding polyethylene glycol to the reaction vessel, and reacting at a temperature of 90° C.-95° C. for 30-35 minutes;
4) adding trimethylolpropane to the reaction vessel and reacting at a temperature of 90° C.-95° C. for 30-35 minutes;
5) adding a catalyst to the reaction vessel, reacting at a temperature of 95° C.-100° C., and testing NCO value until reaching 1-3% of a theoretical value;
6) adding a solvent to the reaction vessel and stirring uniformly to prepare a polyurethane prepolymer;
7) cooling the prepolymer to a temperature of less than 15° C. and adding triethylamine for neutralization for 3-5 minutes;
8) adding pure water and emulsifying the prepolymer for 30-35 minutes to obtain thoroughly emulsified prepolymer;
9) adding ethylenediamine to the emulsified prepolymer for chain extension for 30-35 minutes; and
10) removing the solvent to obtain the waterborne polyurethane material.

2. The method according to claim 1, wherein the reacting of polyester polyol and toluene diisocyanate is at 90° C.

3. The method according to claim 1, wherein the solvent is acetone.

4. The method according to claim 1, wherein the catalyst is bismuth isooctanoate and/or bismuth neodecanoate.

5. The method according to claim 1, wherein a molar ratio among the polyester polyol, the toluene diisocyanate, the dimethylolpropionic acid, the butanediol, the polyethylene glycol, the trimethylolpropane, the catalyst, the solvent, the triethylamine, the pure water and the ethylenediamine is 2:6.1-6.3:0.9-1.0:0.9-1.0:0.08-0.09:0.66-0.67:0.001:63-64:0.99-1.0:460-470:1.17-1.18.

6. The method according to claim 1, wherein a molar ratio among the polyester polyol, the toluene diisocyanate, the dimethylolpropionic acid, the butanediol, the polyethylene glycol, the trimethylolpropane, the catalyst, the solvent, the triethylamine, the pure water and the ethylenediamine is 2:6.229:0.994:0.986:0.089:0.663:0.001:63.473:0.994:460.815:1.173.

7. The method according to claim 1, wherein the polyester polyol is a reaction product of adipic acid and ethylene glycol, the polyester polyol has an acid value of less than or equal to 0.3 mgKOH/g, a hydroxyl value of 54-58 mgKOH/g, a viscosity of 450-600 cP/75° C., and a water content of less than or equal to 0.03%.

8. The method according to claim 1, wherein the dimethylolpropionic acid has an acid value of 410-425 mgKOH/g, a water content of less than or equal to 0.03% and a hydroxyl value of greater than or equal to 24%.

9. The method according to claim 1, wherein the butanediol is 1,4-butanediol and/or 2,3-butanediol.

10. The method according to claim 1, wherein the butanediol is 1,4-butanediol.

11. A waterborne polyurethane material manufactured utilizing the method according to claim 1, wherein a solid content of the waterborne polyurethane material is 40% to 43%, based on a total weight of the waterborne polyurethane material.

12. A method for preparing gloves from the waterborne polyurethane material according to claim 11, the method comprising:
(1) immersing a first-state dry mold in a coagulant mixture of 1-5% calcium nitrate and 1-5% release agent under a condition of 50° C.-60° C. for 10-15 seconds, and then lifting it out to obtain a first-state wet mold;
(2) drying the first-state wet mold under a condition of 120° C.-130° C. for 30 seconds to obtain a second-state dry mold;
(3) immersing the second-state dry mold in a mixture of the waterborne polyurethane material and a cross-linking agent under a condition of 50° C.-60° C. for 10-30 seconds, and then lifting it out to obtain a second-state wet mold with a glove film layer;
(4) drying the second-state wet mold with the glove film layer under a condition of 120° C.-130° C. for 30 seconds to obtain a third-state dry mold with the glove film layer;
(5) immersing the third-state dry mold with the glove film layer in an anti-stick coating solution under a condition of 50° C.-60° C. for 5-10 seconds, and then lifting it out to obtain a third-state wet mold with the glove film layer;
(6) rolling an edge of the glove film layer on the third-state wet mold utilizing a lip rolling machine to obtain a fourth-state wet mold with the glove film layer;
(7) drying the fourth-state wet mold with the glove film layer under a condition of 100° C.-120° C. for 5 minutes to obtain a fourth-state dry mold with the glove film layer;
(8) drying the fourth-state dry mold with the glove film layer under a condition of 80° C.-89° C. for 10 minutes to obtain a fifth-state dry mold with the glove film layer; and
(9) demolding to obtain a polyurethane glove.

13. The method according to claim 12, wherein the cross-linking agent is an amino resin.

14. The method according to claim 12, wherein the cross-linking agent is 1-10% based on a total weight of the mixture of the waterborne polyurethane material and the cross-linking agent.

15. The method according to claim 12, wherein the cross-linking agent is 2-5% based on a total weight of the mixture of the waterborne polyurethane material and the cross-linking agent.

16. The method according to claim 12, wherein a solid content of the mixture of the waterborne polyurethane material and the cross-linking agent is 17-19% based on a total weight of the mixture of the waterborne polyurethane material and the cross-linking agent.

17. The method according to claim 12, further comprising, after the (3) immersing and prior to the (4) drying:
drying the second-state wet mold with the glove film layer under a condition of 120° C.-130° C. for 30 seconds to have a dried mold,
immersing the dried mold in the mixture of the waterborne polyurethane material and the cross-linking agent for a second time for 10-15 seconds, and
lifting it out to thereby obtain the second-state wet mold with the glove film layer after the second operation.

18. The method to claim 12, further comprising cleaning a mold prior to the (1) immersing of the first-state dry mold in the coagulant mixture, wherein the cleaning comprises:
act 1, immersing the mold in an acid washing tank with a pH of 1-2 under a condition of 50° C.-60° C. for 10-15 seconds, and then lifting it out;
act 2, immersing the mold in a water washing tank under a condition of 50° C.-60° C. for 10-15 seconds, and then lifting it out;
act 3, immersing the mold in an alkaline washing tank with a pH of 13-14 under a condition of 50° C.-60° C. for 10-15 seconds, and then lifting it out;
act 4, cleaning the mold with a plate brush under a condition of 50° C.-60° C. for 15-20 seconds;
act 5, immersing the mold in a water washing tank under a condition of 50° C.-60° C. for 10-15 seconds, and then lifting it out; and
act 6, drying the mold under a condition of 120° C.-130° C. for 30 seconds to obtain the first-state dry mold.

19. A glove manufactured by the method according to claim 12.

20. The glove according to claim 19, wherein the glove has a tensile strength of 6.0 N or greater and an elongation rate of 650% or greater.
